(19) United States
(12) Patent Application Publication
(10) Pub. No.: US 2021/0073503 A1
(43) Pub. Date: Mar. 11, 2021

(54) FINGERPRINT AUTHENTICATION DEVICE

(71) Applicant: KABUSHIKI KAISHA TOKAI RIKA DENKI SEISAKUSHO, Aichi (JP)

(72) Inventors: Yosuke OHASHI, Aichi (JP); Rijin OWAKI, Aichi (JP); Fumitaka YOSHIKAWA, Aichi (JP)

(21) Appl. No.: 16/957,472

(22) PCT Filed: Dec. 13, 2018
(86) PCT No.: PCT/JP2018/045924

§ 371 Date: Jun. 24, 2020

(30) Foreign Application Priority Data
Dec. 28, 2017 (JP) 2017-254149

(51) Int. Cl. G06K 9/00

(52) U.S. Cl. CPC G06K 9/0002

(57) ABSTRACT

A fingerprint authentication device includes an authentication unit by which the smallest detection value among detection values resulting from a plurality of touches performed on a detection surface to register a fingerprint is set as a detection threshold for fingerprint detection performed after the registration.

### CROSS-REFERENCES TO RELATED APPLICATIONS

The present patent application claims the priority of Japanese patent application No. 2017/254149 filed on Dec. 28, 2017, and the entire contents of Japanese patent application No. 2017/254149 are hereby incorporated by reference.

### TECHNICAL FIELD

The present invention relates to a fingerprint authentication device.

### BACKGROUND ART

A start control device is known which is provided with a start switch giving an instruction to start or stop a drive source, a start-up means for starting the drive source, a fingerprint sensor for scanning fingerprints, and a control means which, based on inputs from the fingerprint sensor and the start switch, implements a start-up process to control activation. of the start-up means e.g., Patent Literature 1).

When the start switch gives an instruction to start, the control means of the start control device performs fingerprint verification by comparing a fingerprint scanned by the fingerprint sensor with a pre-registered fingerprint before start-up by the start-up means, and once a match is found, the control means authenticates the user as a genuine user and allows the start-up means to start up.

### CITATION LIST

### Patent Literature

Patent Literature 1: JP 2008/174095 A

### SUMMARY OF INVENTION

### Technical Problem

In case of the start control device described in Patent Literature 1, if the detection threshold at the time of scanning fingerprints is set to high so that, e.g., false detection due to variation between individuals who register fingerprints is reduced, an operating finger may not be detected even though it is touching. On the other hand, when the detection threshold is set to low, false detection may increase.

It is an object of the invention to provide a fingerprint authentication device which can set an appropriate detection threshold.

### Solution to Problem

According to an embodiment of the invention, a fingerprint authentication device comprises an authentication unit by which the smallest detection value among detection values resulting from a plurality of touches performed on a detection surface to register a fingerprint is set as a detection threshold for fingerprint detection performed after the registration.

### Advantageous Effects of Invention

According to an embodiment of the invention, it is possible to provide a fingerprint authentication device which can set an appropriate detection threshold.

### BRIEF DESCRIPTION OF DRAWINGS

FIG. 1A is an explanatory diagram illustrating a fingerprint authentication device in an embodiment.

FIG. 1B is a block diagram illustrating the fingerprint authentication device in the embodiment.

FIG. 2A is an explanatory diagram illustrating an operation to shift from normal mode to registration mode and perform registration of a fingerprint in the fingerprint authentication device in the embodiment.

FIG. 2B is an explanatory diagram illustrating the normal mode of the fingerprint authentication device in the embodiment when using an updated detection threshold.

FIG. 2C is an explanatory diagram illustrating the normal mode of the fingerprint authentication device in the embodiment when using the updated detection threshold.

FIG. 3A is an explanatory diagram illustrating an operation to shift from the normal mode to the registration mode and perform registration of an additional fingerprint in the fingerprint authentication device in the embodiment.

FIG. 3B is an explanatory diagram illustrating an operation to shift from the normal mode to the registration mode and perform registration of an additional fingerprint in the fingerprint authentication device in the embodiment.

FIG. 4 is a flowchart showing an example of an operation of the fingerprint authentication device in the embodiment.

### DESCRIPTION OF EMBODIMENTS

### Summary of the Embodiment

A fingerprint authentication device in an embodiment is generally configured to have an authentication unit by which the smallest detection value among detection values resulting from a plurality of touches performed on a detection surface to register a fingerprint is set as a detection threshold for fingerprint detection performed after the registration.

This fingerprint authentication device is configured that the smallest detection value at the time of registration is used as the detection threshold after the registration. Therefore, unlike when the detection threshold is fixed, it is possible to set an appropriate detection threshold.

### Embodiment

### General Configuration of Fingerprint Authentication Device 1

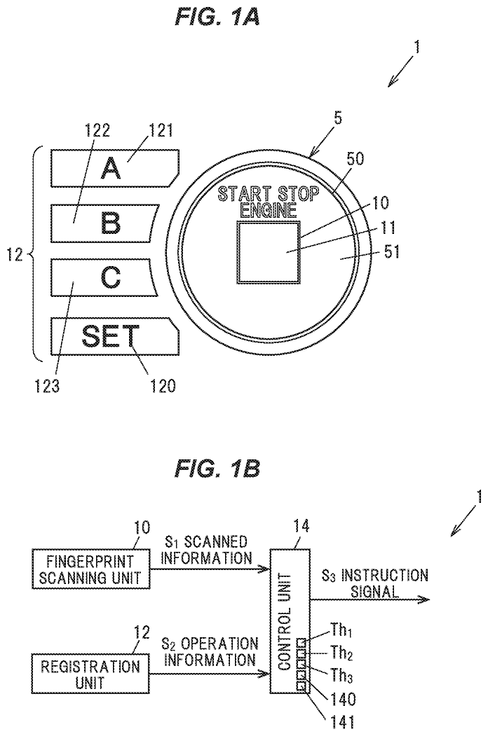

FIG. 1A is a schematic diagram illustrating an example of a fingerprint authentication device in the embodiment, and FIG. 1B is an example block diagram of the fingerprint authentication device. In each drawing of the embodiment described below, a scale ratio may be different from an actual ratio. In addition, in FIG. 1B, flows of main signal and information are indicated by arrows.

The fingerprint authentication device 1 is to perform authentication of fingerprint which is one of biometric information. The fingerprint authentication device 1 is arranged on a start switch 5 of a vehicle as shown in FIG. 1A as an example, but it is not limited thereto. It may be arranged on an electronic device such as smartphone or personal computer.

The fingerprint authentication device 1 is generally configured to have, e.g., a control unit 14 as an authentication unit by which the smallest detection value among detection values resulting from plural touches performed on a detection surface 11 to register a fingerprint is set as a detection threshold (an update detection threshold Th₃) for fingerprint detection performed after the registration, as shown in FIGS. 1A and 1B.

As an example, the fingerprint authentication device 1 is provided with a registration unit 12 for registering plural fingerprints.

### Configuration of the Start Switch 5

The start switch 5 is arranged on, e.g., in front of an operator sitting in a driver's seat or on a floor console located between the driver's seat and the front passenger seat. The start switch 5 instructs a vehicle to start, or to prepare to start, a drive system of the vehicle by a push operation (ON operation) performed on an operation surface 51 of an operation button 50, and instructs to stop the drive system by a next push operation (OFF operation).

The start switch 5 in the present embodiment mounts the fingerprint authentication device 1 and is thus configured to output a signal instructing to start the drive system when a push operation is detected and a fingerprint of an operating finger touched the detection surface 11 at the time of the push operation is authenticated by the fingerprint authentication device 1.

### Configuration of Fingerprint Scanning Unit 10

A fingerprint scanning unit 10 is arranged so that the detection surface 11 is exposed at the center of the operation surface 51 of the start switch 5. For example, a sensor configured to scan a fingerprint pattern, such as capacitive, electric field strength measuring, pressure-sensative, or thermal-sensitive type is used as the fingerprint scanning unit 10.

The fingerprint scanning unit 10 in the present embodiment is a capacitive sensor, as an example. The fingerprint scanning unit 10 is configured to detect a capacitance value C generated between itself and the operating finger which touches the operation surface 51 to operate the start switch 5, and also to scan a fingerprint of the operating finger.

As an example, the fingerprint scanning unit 10 has plural electrodes located under the detection surface 11 and intersecting in an insulated state. The fingerprint scanning unit 10 is configured to, e.g., drive one electrode intersecting in one direction, to sequentially read the capacitance values C generated between the electrode and the operating finger by electrodes intersecting in the other direction, and to generate scanned information S₁ including information corresponding to the fingerprint obtained by image processing and information of a total capacitance value C_{T} as a detection value which is the sum of the capacitance values C for one cycle of scanning. As an example, the fingerprint scanning unit 10 converts the detected capacitances into digital values and calculates the sum of the values.

In the present embodiment, the total capacitance value C_{T} is used as the detection value as an example, but it is not limited thereto. A maximum value or a peak value of the read capacitance values may be used as the detection value.

The fingerprint authentication device 1 may be configured such that, e.g., the fingerprint scanning unit 10 outputs the capacitance values C to the control unit 14 and the control unit 14 calculates the total capacitance value C_{T}.

### Configuration of Registration Unit 12

As an example, the registration unit 12 has a set button 120 and registration buttons 121 to 123, which are arranged in the vicinity of the start switch 5, as shown in FIG. 1A. The set button 120 and the registration buttons 121 to 123 are configured as, e.g., push buttons, but are not limited thereto and may be touch switches.

The set button 120 and the registration buttons 121 to 123 are a group of buttons which are pressed when registering fingerprints or when identifying a registered individual by the fingerprint.

A word “SET” is printed on the set button 120, as an example. Alphabets “A” to “C” are printed on the registration buttons 121 to 123, as an example. These “A” to “C” indicate registration A to registration C. The number of registration buttons and the number of biometrics which can be registered are arbitrary.

An operator, when registering his/her fingerprint, presses the set button 120, then presses the registration button selected to register a fingerprint, and places the operating finger onto the detection surface 11, as an example. In this registration operation, registration information 140 associating the operated button with a fingerprint template is stored in the control unit 14.

When, after the registration, the registered individual presses the registration button used to register the fingerprint and subsequently performs an ON operation on the start switch 5, authentication is performed by comparing the fingerprint of the registered individual with the fingerprint template included in the registration information 140.

The fingerprint template here is used for authentication of fingerprint and consists of characteristic features of the fingerprint. To perform authentication, the control unit 14 extracts the characteristic features of the scanned fingerprint and calculates the degree of match against the template, as an example.

The registration unit 12 generates, e.g., operation information S₂ corresponding to a combination of pressed registration buttons and outputs it to the control unit 14. The control unit 14 determines whether it is the normal mode or the registration mode, etc., based on the operation information S₂.

As a modification, the fingerprint authentication device 1 may be configured that, e.g., more than three fingerprints can be registered by combining the registration buttons. When, e.g., a fingerprint A is already registered in the fingerprint authentication device 1, the same registered individual can register a fingerprint B in addition to the fingerprint A by pressing the registration button 121 “A” as well as the registration buttons 122 “B”.

Also as a modification, the fingerprint authentication device 1 may be configured to, e.g., identify an individual having a registered fingerprint by communication with an electronic key and to register plural fingerprints of the same registered individual.

### Configuration of the Control Unit 14

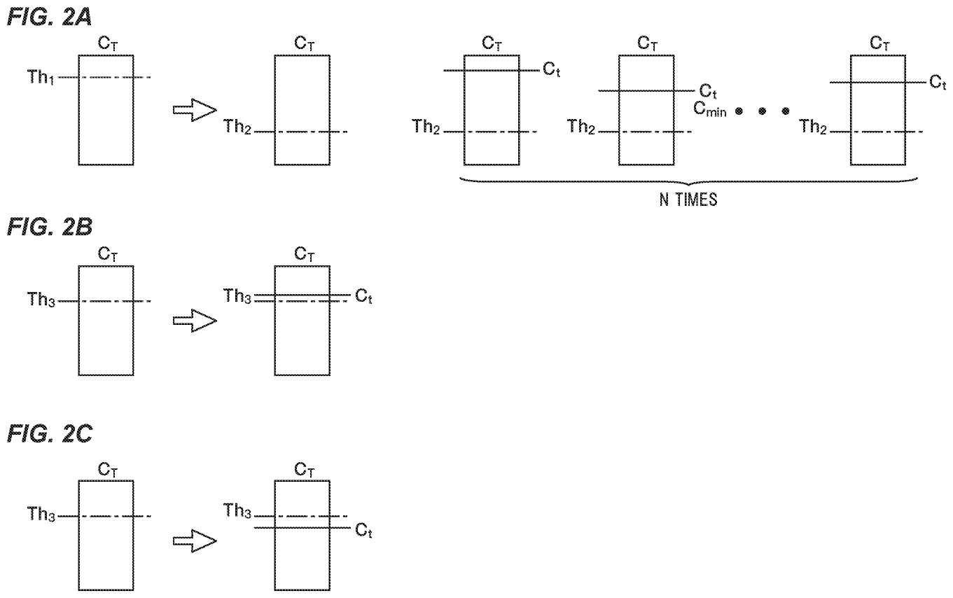

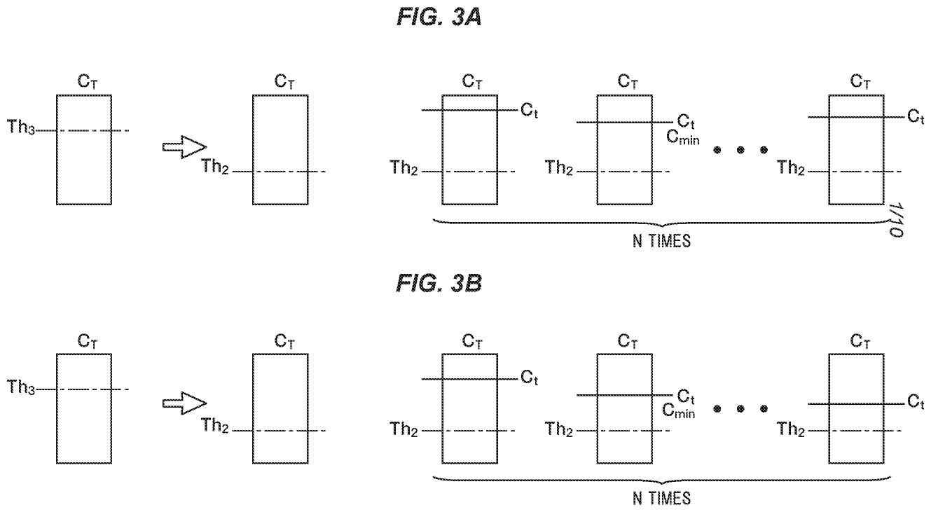

FIG. 2A is an explanatory schematic diagram illustrating an example of an operation to shift from the normal mode to the registration mode and perform registration of a fingerprint in the fingerprint authentication device in the embodiment, and FIGS. 2B and 2C are explanatory schematic diagrams illustrating an example of the normal mode using an updated detection threshold. FIGS. 3A and 3B are explanatory schematic diagrams illustrating an example of an operation to shift from the normal mode to the registration mode and perform registration of an additional fingerprint. The area of each rectangle shown in FIGS. 2A, 2B, 2C, 3A and 3B represents the total capacitance value C_{T}. In addition, the detected total capacitance value is denoted by Cₜ. Furthermore, FIGS. 2A, 3A and 3B show part of N times of touches performed to create a template (as an example, N is a positive integer larger than 1).

The control unit 14 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the control unit 14, an initial detection threshold Th₁, a registration detection threshold Th₂, the update detection threshold Th₃, the registration information 140, and a similarity threshold 141. The RAM is used as, e.g., a storage area for temporarily storing calculation results, etc.

When authentication of the fingerprint is successful, the control unit 14 outputs an instruction signal S₃ which indicates successful authentication. The start switch 5 gives an instruction to start the drive system when a push operation is detected and the instruction signal S₃ indicating successful fingerprint authentication is input.

The initial detection threshold Th₁ is a default value which is set when any fingerprint is not registered. The initial detection threshold Th₁ is set to higher than the registration detection threshold Th₂.

The registration detection threshold Th₂ is a detection threshold for the registration mode used when registering a fingerprint.

The update detection threshold Th₃ is a detection threshold which is set based on a smallest total capacitance value Cₘᵢₙ obtained at the time of registering the fingerprint. The initial detection threshold Th₁, the registration detection threshold Th₂ and the update detection threshold Th₃ are detection thresholds for determining a touch by the operating finger on the detection surface 11, in other words, for determining whether or not to perform authentication of fingerprint.

The similarity threshold 141 is a threshold value related to the degree of match obtained when comparing the characteristic features of the scanned fingerprint to the registered fingerprint template. As an example, when the number of the characteristic features to be compared is 100 and the number of matches found between the characteristic features of the scanned fingerprint and the characteristic features of the template is not less than “70” which is the similarity threshold 141, the control unit 14 authenticates the operator as the registered individual who has the registered fingerprint.

Next, registration of fingerprint will be described.

### Registration of Fingerprint

The control unit 14 is configured to set the total capacitance value Cₘᵢₙ, which is the smallest among the plural total capacitance values Cₜ obtained at the time of registering the fingerprint, as the update detection threshold Th₃. The control unit 14 is also configured to switch from the preset initial detection threshold Th₁ to the lower registration detection threshold Th₂ at the time of registration of fingerprint.

In detail, the control unit 14 sets, e.g., the initial detection threshold Th₁ in a state that any fingerprint is not registered, as shown in FIG. 2A. Subsequently, when it is determined, based on the operation information S₂ input from the registration unit 12, that the registration mode is instructed, the control unit 14 lowers the detection threshold from the initial detection threshold Th₁ to the registration detection threshold Th₂ so that the fingerprint can be easily detected.

Next, the control unit 14 obtains plural total capacitance values Cₜ from N times of touches on the detection surface 11 which are performed, e.g., until a necessary and sufficient template is created. The control unit 14 targets only the total capacitance values Cₜ not less than the registration detection threshold Th₂ and creates the template using plural fingerprints with which such total capacitance values Cₜ are obtained.

Next, the control unit 14 newly sets the smallest total capacitance value Cₜ (Cₘᵢₙ), which is not less than the registration detection threshold Th₂ and is one of the total capacitance values Cₜ obtained before the template is created, as the update detection threshold Th₃.

### Authentication Using Registration Detection Threshold Th₂

The control unit 14 is configured to not perform authentication of fingerprint when the detection value (the detected total capacitance value Cₜ) is smaller than the detection threshold (the update detection threshold Th₃).

In detail, when, e.g., the fingerprint template is created and the registration mode ends, the control unit 14 changes to the normal mode in which authentication of fingerprint is performed using the update detection threshold Th₃ as the detection threshold.

Then, the control unit 14 acquires the scanned information S₁ from the fingerprint scanning unit 10 and firstly compares the total capacitance value Cₜ with the update detection threshold Th₃. Then, when the total capacitance value Cₜ is not less than the update detection threshold Th₃ as the example shown in FIG. 2B, the control unit 14 subsequently performs authentication of fingerprint.

On the other hand, when the total capacitance value Cₜ is smaller than the update detection threshold Th₃ as the example shown in FIG. 2C, the control unit 14 does not perform authentication of fingerprint.

### Registration of Additional Fingerprint

The control unit 14 is configured to not update the already set detection threshold (the update detection threshold Th₃) when a detection value (the total capacitance value Cₜ) resulting from a touch performed on the detection surface 11 to register an additional fingerprint is a detection value (the total capacitance value Cₜ) not less than the already set detection threshold (the update detection threshold Th₃).

The control unit 14 is also configured to operate such that, when the detection value (the total capacitance value Cₜ) resulting from a touch performed on the detection surface 11 to register an additional fingerprint is a detection value (the total capacitance value Cₜ) lower than the already set detection threshold (the update detection threshold Th₃), the already set detection threshold (the update detection threshold Th₃) is updated to the lower detection value (the total capacitance value Cₜ).

In detail, when the same registered individual additionally registers a fingerprint, the control unit 14 lowers the threshold from the update detection threshold Th₃ to the registration detection threshold Th₂ as the example shown in FIG. 3A so that the fingerprint can be easily detected.

Next, the control unit 14 obtains plural total capacitance values Cₜ from N times of touches on the detection surface 11 which are performed, e.g., until a necessary and sufficient template is created.

Next, the control unit 14 compares the smallest total capacitance value Cₜ (Cₘᵢₙ), which is not less than the registration detection threshold Th₂ and is one of the total capacitance values Cₜ obtained before the template is created, to the update detection threshold Th₃ before being reduced. When the smallest total capacitance value Cₜ (Cₘᵢₙ) is not less than the update detection threshold Th₃ as the example shown in FIG. 3A, the control unit 14 terminates the registration mode without updating the update detection threshold Th₃.

On the other hand, when the smallest total capacitance value Cₜ (Cₘᵢₙ) is lower than the update detection threshold Th₃ as the example shown in FIG. 3B, the control unit 14 terminates the registration mode after updating the update detection threshold Th₃ to such a smallest total capacitance value Cₜ (Cₘᵢₙ).

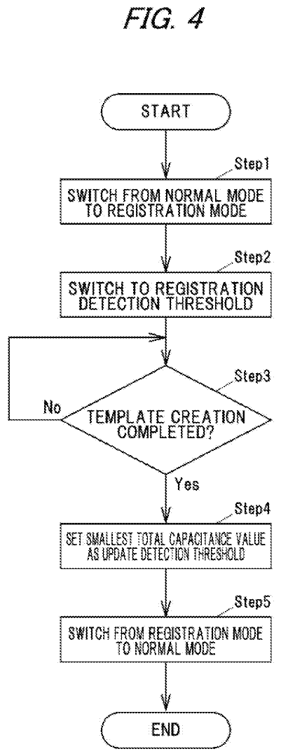

Next, an example of an operation of the fingerprint authentication device 1 in the present embodiment when in the registration mode will be described in reference to the flowchart of FIG. 4.

### Operations

When it is determined, based on the operation information S₂ input from the registration unit 12, that the registration mode is instructed, the control unit 14 of the fingerprint authentication device 1 switches from the normal mode to the registration mode (Step 1). Then, the control unit 14 changes from the currently set detection threshold (the initial detection threshold Th₁ or the update detection threshold Th₃) to the registration detection threshold Th₂ (Step 2).

Next, based on the scanned information S₁ input from the fingerprint scanning unit 10, the control unit 14 creates a template, using fingerprints with the total capacitance values Cₜ not less than the registration detection threshold Th₂.

When it is “Yes” in Step 3, i.e., when the template is created (Step 3: Yes), the control unit 14 sets the smallest total capacitance value Cₜ (Cₘᵢₙ) among the total capacitance values Cₜ of the fingerprints used to create the template, as the update detection threshold Th₃ (Step 4).

At this stage, in case that the registration mode is a mode for registering an additional fingerprint, i.e., in case that the update detection threshold Th₃ has been already set, the control unit 14 updates the update detection threshold Th₃ only when the smallest total capacitance value Cₜ is lower than the already set update detection threshold Th₃.

Then, after setting the update detection threshold Th₃, the control unit 14 switches from the registration mode back to the normal mode (Step 5) and ends the registration process.

### Effects of the Embodiment

The fingerprint authentication device 1 in the present embodiment can set an appropriate detection threshold. In detail, in the fingerprint authentication device 1, the smallest total capacitance value Cₜ (Cₘᵢₙ) obtained in the registration mode is set and used as the update detection threshold Th₃ in the normal mode. Therefore, unlike when the detection threshold is fixed, it is possible to set a detection threshold appropriate for the registered individual and this reduces false detection or no detection. In addition, the fingerprint authentication device 1 is configured that the smallest total capacitance value Cₜ (Cₘᵢₙ), which is obtained when the operator intentionally touches the detection surface 11 until the fingerprint template is created, is set as the update detection threshold Th₃. Therefore, accuracy as the threshold is high as compared to when such a configuration is not adopted.

The fingerprint authentication device 1 lowers the detection threshold to the registration detection threshold Th₂ in the registration mode. Therefore, unlike when such a configuration is not adopted, the fingerprint is easily detected and the appropriate smallest total capacitance value Cₜ (Cₘᵢₙ) is easily obtained.

In case that the same registered individual additionally registers a fingerprint and when the smallest total capacitance value Cₜ (Cₘᵢₙ) lower than the currently used update detection threshold Th₃ is obtained, the fingerprint authentication device 1 makes an update. Therefore, unlike when such a configuration is not adopted, it is possible to set a further appropriate detection threshold. In addition, since the fingerprint authentication device 1 does not update when the smallest total capacitance value Cₜ (Cₘᵢₙ) obtained in the additional registration mode is not less than the currently used update detection threshold Th₃, it is possible to maintain the appropriate detection threshold.

The fingerprint authentication device 1 does not perform authentication of fingerprint when the total capacitance value Cₜ is lower than the update detection threshold Th₃. Therefore, unlike when such a configuration is not adopted, the processing load of the control unit 14 is reduced.

Although some embodiment and modifications of the invention have been described, these embodiment and modifications are merely examples and the invention according to claims is not to be limited thereto. These new embodiment and modifications may be implemented in various other forms, and various omissions, substitutions and changes, etc., can be made without departing from the gist of the invention. In addition, all combinations of the features described in these embodiment and modifications are not necessary to solve the problem of the invention. Further, these embodiment and modifications are included within the scope and gist of the invention and also within the invention described in the claims and the range of equivalency.

### REFERENCE SIGNS LIST

1 FINGERPRINT AUTHENTICATION DEVICE

10 FINGERPRINT SCANNING UNIT

11 DEJECTION SURFACE

12 REGISTRATION UNIT

14 CONTROL UNIT

51 OPERATION SURFACE

Th₁ INITIAL DETECTION THRESHOLD

Th₂ REGISTRATION DETECTION THRESHOLD

Th₃ UPDATE DETECTION THRESHOLD

1. A fingerprint authentication device, comprising an authentication unit by which the smallest detection value among detection values resulting from a plurality of touches performed on a detection surface to register a fingerprint is set as a detection threshold for fingerprint detection performed after the registration.

2. The fingerprint authentication device according to claim 1, wherein, when registering a fingerprint, the authentication unit changes to a registration detection threshold that is lowered from a preset initial detection threshold.

3. The fingerprint authentication device according to claim 1, wherein, when a detection value resulting from a touch performed on the detection surface to register an additional fingerprint is a detection value not less than the already set detection threshold, the authentication unit does not update the detection threshold.

4. The fingerprint authentication device according to claim 1, wherein, when a detection value resulting from a touch performed on the detection surface to register an additional fingerprint is a detection value lower than the already set detection value, the authentication unit updates the detection threshold to the lower detection value.

5. The fingerprint authentication device according to claim 1, wherein the authentication unit does not perform authentication of fingerprint when a detection value detected is lower than the detection threshold.

6. A fingerprint authentication device, comprising:
a fingerprint scanning unit that comprises a detection surface to be touched by an operating finger and outputs information corresponding to a fingerprint of the operating finger and detection values when the operating finger touches the detection surface; and
an authentication unit by which the smallest detection value among the detection values resulting from a plurality of touches performed on the detection surface to register the information corresponding to the fingerprint is set as a detection threshold for fingerprint detection performed after the registration.

7. The fingerprint authentication device according to claim 6, wherein the fingerprint scanning unit comprises a capacitive sensor.

8. The fingerprint authentication device according to claim 7, wherein the capacitive sensor comprises a plurality of electrodes located under the detection surface and intersecting in an insulated state, drives one electrode intersecting in one direction, sequentially reads capacitances generated between the electrode and the operating finger by electrodes intersecting in the other direction, and outputs the information corresponding to the fingerprint obtained by image processing and a total capacitance value as the detection value, the total capacitance value being defined as a sum of capacitances for one cycle of scanning.

9. The fingerprint authentication device according to claim 7, wherein the capacitive sensor comprises a plurality of electrodes located under the detection surface and intersecting in an insulated state, drives one electrode intersecting in one direction, sequentially reads capacitances generated between the electrode and the operating finger by electrodes intersecting in the other direction, and outputs the information corresponding to the fingerprint obtained by image processing and a maximum value or a peak value of capacitances for one cycle of scanning.

10. The fingerprint authentication device according to claim 6, further comprising a registration instruction unit that gives an instruction to register the information corresponding to the fingerprint.
